(19) United States
(12) Patent Application Publication
(10) Pub. No.: US 2007/0258756 A1
(43) Pub. Date: Nov. 8, 2007

(54) Means for connecting plastic parts

(76) Inventor: Michael Cohnitz Olshausen, Washington, DC (US)

Correspondence Address: MICHAEL COHNITZ OLSHAUSEN, P.O. BOX 18653, WASHINGTON, DC, 20036, US

(21) Appl. No.: 11/418,246

(22) Filed: May 5, 2006

(51) Int. Cl. F16D 1/072

(52) U.S. Cl. 403/274

(57) ABSTRACT

An integrally formed means for connecting plastic parts that exploits persistent, resilient deformation through studs that are pressed in and through double-tapered holes wherein a neck smaller in cross section than the corresponding studs has been formed. By varying the relative cross sections of neck and stud connection strength may be adjusted. By providing studs shorter than the double-tapered hole, cavities become available for chemically converting the reversible, frictional cum interference connections into permanent connections. By adjusting the height 11 of the neck relative to the length of the corresponding studs, parts may be kept in registry and their assembly thus eased. Parts having side walls of sufficient height, although connected in principal reversibly, in practical effect become irreversibly connected. Such connective means may reduce the need for ultra-sonic welding, reliably reported to disturb electrical circuitry mounted on parts to be connected.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### SEQUENCE LISTING

Not Applicable

### BACKGROUND OF THE INVENTION

This invention relates to connectors for plastic parts, in particular to integrally formed connectors that take advantage of plastic's evident plasticity. One broad family of such connectors relies upon mechanical interlock, typically achieved through undercuts. Child-proof safety lids offer many good examples. A second family of plastic connectors relies exclusively on friction, created by resilient deformation. The integrally formed connectors found in the Lego® toy building blocks, first disclosed in U.S. Pat. No. 3,005,282 to Christiansen (1961) are an example. The present invention is a hybrid form. It belongs to the second family, yet is different from many members of that family, including the original Lego® blocks, in that it avoids blind holes. It-also belongs to the first family, yet is different from many members of that family by achieving the effect of undercuts entirely through persistent resilient deformation rather than subsequent to a single resilient deformation. The present invention is very easy to mold, achieves a reversible connection of adjustable strength, and yet has a form that can quickly and conveniently be treated by chemical means to achieve a permanent connection.

### SURVEY OF BACKGROUND ART

The applicant is unaware of any integrally formed connector in the patent literature that directly anticipates the totality of the present invention.

U.S. Pat. No. 557,037 to Toquet (1896) shows a cylinder, in particular a wire, slid inside a closely fitting sleeve, both of which, sleeve and wire, are then crimped, forming a neck at the crimp. This neck, however, is not produced by a resilient deformation of the materials, rather the neck is forced upon the materials through an irreversible, hoop-stress induced, inelastic deformation.

U.S. Pat. No. 3,719,003 to Skjoldborg (1973) shows a double-tapered hole 14 which is, however, a blind hole. The present invention rejects blind holes as disadvantageous. Skjoldborg's tenon 12 snaps into hole 14 by virtue of the plasticity of the material, however Skjoldborg's tenon is itself double-tapered, and in fact is substantially congruent to blind hole 14. The present invention rejects substantial congruity as disadvantageous.

U.S. Pat. No. 4,116,105 to Herman (1978) results in a cross-sectional deformation of materials that superficially resembles the deformation produced by the present invention (preview FIG. 7). However, Herman's fastener achieves this deformation by shooting a bullet into the surrounding material! The present invention requires no gun.

### BRIEF SUMMARY OF THE INVENTION

The present invention comprises, minimally, two plastic elements, wherein the first element itself comprises at least one stud, and wherein the second element itself comprises at least one double-tapered open hole having a smallest cross section (as measured by area or a representative linear dimension thereof) smaller than any engageable cross section of the stud (as similarly measured), thus forming within the double taper of the open hole a narrowing, or neck, and further wherein the stud is so disposed that it can be pressed down into the double-tapered open hole and past the neck therein, in virtue of the plasticity of the material, thereby forming an interference connection of the first to the second element that is further strengthened by the elements' frictional engagement. The connection strength may be adjusted by varying the neck cross section relative to the stud cross section. Since the forces exerted on the stud during deformation are compressive and primarily along its long axis, the forces may be allowed to grow surprisingly large before the stud buckles or snaps off.

When pressed fully into the hole, the stud, together with adjacent the material, forms a very tight seal. In the invention's preferred embodiment, the stud is cylindrical and shorter in length than the double-tapered hole. Hence, a shallow cavity results between the end of the stud and the rear, conical surface of the double-tapered, open hole. Following the connection of the first to the second element, this cavity may be pointed upwards and plastic glue easily deposited into it to form, by chemical means, a permanent connection. Liquid glue will not escape past the seal tightly formed by the connected elements.

If one of the elements is provided with side walls, and if the second element fits very narrowly within those side walls, then the reversible interference connection becomes, in a practical sense, a irreversible connection. There will simply be too little space between the side walls and the second element to insert prying tools sufficiently strong to break the connection without first marring the finished product.

A finished product may be such that some part or portion of the second element, perhaps a component of an electronic circuit mounted thereupon, protrudes through an aperture in the external surface of the first element, after the elements are connected. Inasmuch as stud length as well as neck height within the double-tapered hole may be varied, these two parameters may be chosen so that, before actual connection is effected, the stud and the double-tapered, open hole act as guides during assembly, keeping in registry both part and aperture. This greatly eases assembly.

The present invention thus has several important objects, among which are:
1) to connect plastic parts strongly yet reversibly;
2) to provide a means of connection integrally formed with the parts to be connected but without the use of undercuts, so that standard, straight pull molds are sufficient to form at least the means of connection;
3) to provide a means of connection that can be easily transformed from reversible to irreversible;
4) to provide a means of connection that can act as a guide during parts assembly;
5) to provide for an adjustable connection strength.

These and still-further objects and advantages of the present invention will become apparent from a consideration of the following drawing, detailed description, and appended claims.

### BRIEF DESCRIPTION OF THE SEVERAL VIEWS OF THE DRAWING

Referring to the drawing, wherein like reference characters indicate like parts or elements throughout the several views, and wherein arrowheads indicate physically-composite objects whose numbered resolution into constituent parts occurs only when it is germane to the discussion:

FIG. 1 is a cross-sectional view in a plane containing the axis of rotational symmetry of the elements of the preferred embodiment of the present invention.

FIG. 2 shows the elements of FIG. 1 brought into contact along the axis of symmetry.

FIG. 3 shows one element of the invention but with an angle exaggerated to establish a sign convention.

FIG. 4 shows one element of the invention but with an angle exaggerated in the opposite sense of the exaggeration in FIG.3.

FIG. 5 shows the elements of FIG. 1 with the angular and dimensional degrees of freedom annotated.

FIG. 6 shows the elements of FIG. 1 in full engagement.

FIG. 7 is an enlargement of box 7 of FIG. 6.

FIG. 8 is an enlargement of box 8 of FIG. 7 turned upside down.

FIG. 9 is a perspective view of the present invention embodied in a box-like first assembly and panel-like second assembly, the assemblies being disposed to one another at a right angle.

FIG. 10a is a rear perspective view of the assemblies of FIG. 9 after the second assembly has been turned ninety degrees and the elements of the invention have been placed in registry with one another.

FIG. 10b is a side perspective view of the assemblies of FIG. 10a.

FIG. 10c is a stepped, partial cross-sectional view of the assemblies of FIG. 10b. taken along 10c-10c of FIG. 10b.

FIG. 11a shows the assemblies of FIG. 10a moved in registry toward one another but just prior the assemblies's physical first contact.

FIG. 11b is a side perspective view of the assemblies of FIG. 11a.

FIG. 11c is a stepped, partial cross-sectional view taken as FIG. 10c of the assemblies of FIG. 11b.

FIG. 12a shows the assemblies of FIG. 11a after those assemblies's have just been brought into contact with one another.

FIG. 12b is a side perspective view of the assemblies of FIG. 12a.

FIG. 12c is a stepped, partial cross-sectional view taken as FIG. 10c of the assemblies of FIG. 12b.

FIG. 13a shows the assemblies of FIG. 12a after those assemblies have been brought into full physical engagement.

FIG. 13b is a side perspective view of the assemblies of FIG. 13a.

FIG. 13c is a stepped, partial cross-sectional view taken as FIG. 10c of the assemblies of FIG. 13b.

FIG. 14 is a perspective view of the present invention embodied in a box-like first assembly and panel-like second assembly, the assemblies being disposed to one another at a right angle.

FIG. 15a is a rear perspective view of the assemblies of FIG. 14 after the second assembly has been turned ninety degrees and the elements of the invention have been placed in registry with one another.

FIG. 15b is a side perspective view of the assemblies of FIG. 15a.

FIG. 15c is a stepped, partial cross-sectional view taken along 15c-15c of FIG. 15b of the assemblies of FIG. 15b.

FIG. 16a shows of the elements of FIG. 15a after the assemblies' full physical engagement.

FIG. 16b is a side perspective view of the assemblies of FIG. 16a.

FIG. 16c is a stepped, partial cross-sectional view taken as FIG. 15c of the assemblies of FIG. 16b.

FIG. 17 is a transparent perspective view-of an alternate embodiment of the present invention with the alternate embodiment's two elements not yet engaged.

FIG. 18 shows the elements of FIG. 19 in full engagement.

FIG. 19 is an enlargement of box 19 of FIG. 18 but turned upside down-in the manner of FIG. 8 relative to FIG. 7.

### DETAILED DESCRIPTION OF THE PREFERRED EMBODIMENTS OF THE INVENTION

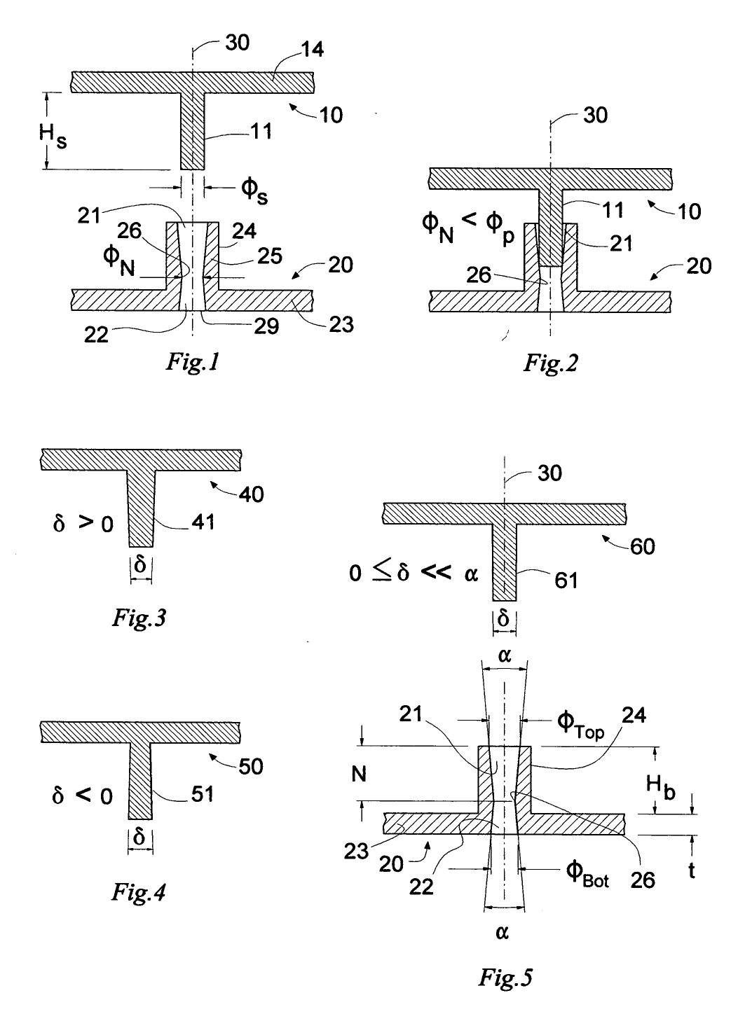

FIG. 1 shows first element 10 and second element 20 of the preferred embodiment of the invention, both rotationally symmetric about axis 30. Extending downward from wall 14 of element 10 is stud 11 having height Hs and end diameter φs. Extending upward from wall 23 of element 20 is boss 24 having side wall 25. Extending axially and entirely through boss 24 and wall 23 is double-tapered hole 29 consisting of funnel shaped portion 21 and funnel shaped portion 22, which meet at annular neck 26 having diameter φN. Neck 26 has the narrowest cross section orthogonal to axis 30 of double-tapered hole 29.

FIG. 2 shows stud 11 of element 10 lowered into funnel portion 21 along axis 30 until stud 11 just makes contact with wall 25. Since φN<φs, the point of contact lies above neck 26.

FIG. 3 shows molded element 40 identical to 10 except that stud 41 is not cylindrical but is in fact a truncated cone with apex angle δ>0. In reality, a molded stud will only rarely be perfectly cylindrical and will instead have some slight non-zero taper to facilitate release from the mold.

FIG. 4 shows milled element 50 identical to 10 except that stud 51 is not cylindrical but is in fact an inverted, truncated cone with apex angle δ<0. A stud of this sort is expensive to mold, yet often results in milling, especially if φs is small relative to Hs.

FIG. 5 shows element 60 identical to 10 except that stud 61 has an apex angle δ, where 0≦δ<<α, α being the apex angle of funnel shaped portion 21 of element 20. Funnel shaped portion 22 also has apex angle α. Since δ is small relative to α, both the diameter φTop of the opening of funnel portion 21 and the diameter φBot of the opening of funnel portion 22 will be substantially greater than the diameter φs of stud 61 measured at its free end. Boss 24 is height Hb above wall 23 of thickness t. Neck 26 of diameter φ_{N} is a distance, or depth, N from the free end of boss 24. The equality of the apex angles of funnel shaped portions 21 and 22 helps to insure that the forces exerted on stud 61 in virtue of material resiliency after the full connection of elements 60 and 20 will not have unequal components along axis 30 that, with the passage of time, might tend to urge stud 61 to move.

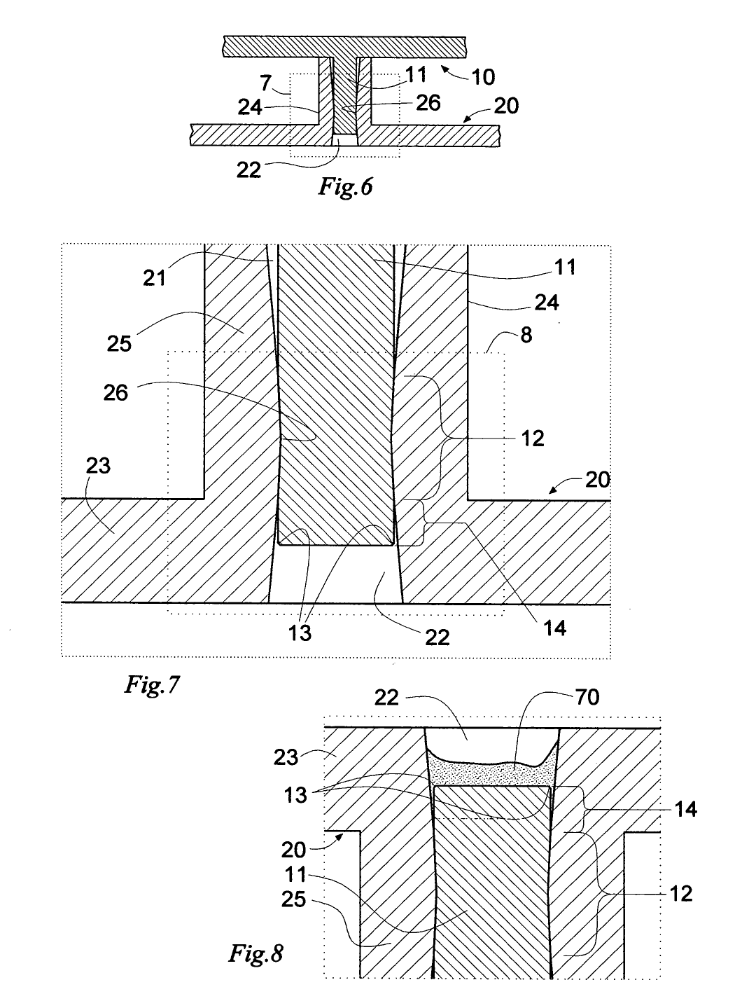

FIG. 6 shows the elements 10 and 20 of FIG. 1 fully engaged, with stud 11 pushed into boss 24 and past neck 26 as far as it will go into funnel portion 22. Dotted box 7 defines the area detailed in FIG. 7. Although elements 10 and 20 are fully engaged, not all cross sections of stud 11 have passed through neck 26, yet more cross sections than have passed through have in fact been engaged by element 20, because of the induced deformation.

FIG. 7 shows in detail the mutual deformation of stud 11 and side wall 25 in region 12. Shown is a Hook's Law, elastic deformation, the physical basis of the present invention. Depending on the material and the ratio φs/φ_{N}, the seal formed by region 12 can be made quite tight. In actual practice using Polyoxymethylene (POM or Acetal, brand name Delrin®), a stud of diameter 0.069″ pressed into a 10° double-tapered hole having a neck diameter of 0.063″ passes the neck with an audible pop, and feels just like a snap connector on a pair of blue jeans. As depicted in FIG. 7, the thickness of side wall 25 at the neck is a fraction of diameter φs. As shown, it equals about ⅔. Stud 11 extends some small distance beyond region 12 into region 14. In regions 12 and 14 are all of the cross sections of stud 11, some now elastically deformed, others returned to their original state before passing through boss 24, which had been engageable by double-tapered, open hole 29 before actual engagement of elements 10 and 20. Exactly which cross sections these are can be estimated from stud height Hs, neck depth N, and the bulk and shear moduli of the material. Roughly, they will include all the cross sections orthogonal to axis 30 of stud 11 from the stud's free end to a point somewhat more than a distance Hs-N behind its free end. Miniature chamfers 13 act as an aid in pushing stud 11 through neck 26. Dotted box 8 defines the area detailed upside down in FIG. 8.

FIG.8 shows the cavity formed by funnel portion 22 immediately above region 12. Stud 11 extends into this cavity as far as region 14, however the cavity is otherwise open. Plastic glue 70 has been deposited into the cavity. Gravity and capillarity have drawn glue 70 down in between wall 25 and stud 11. The seal formed by region 12 prevents glue 70 from penetrating below region 14. The opportunity to form a permanent connection chemically some time after assembly and testing, that is made available by the geometry of the present invention is unavailable to connections formed using blind holes. Hence their disadvantageousness.

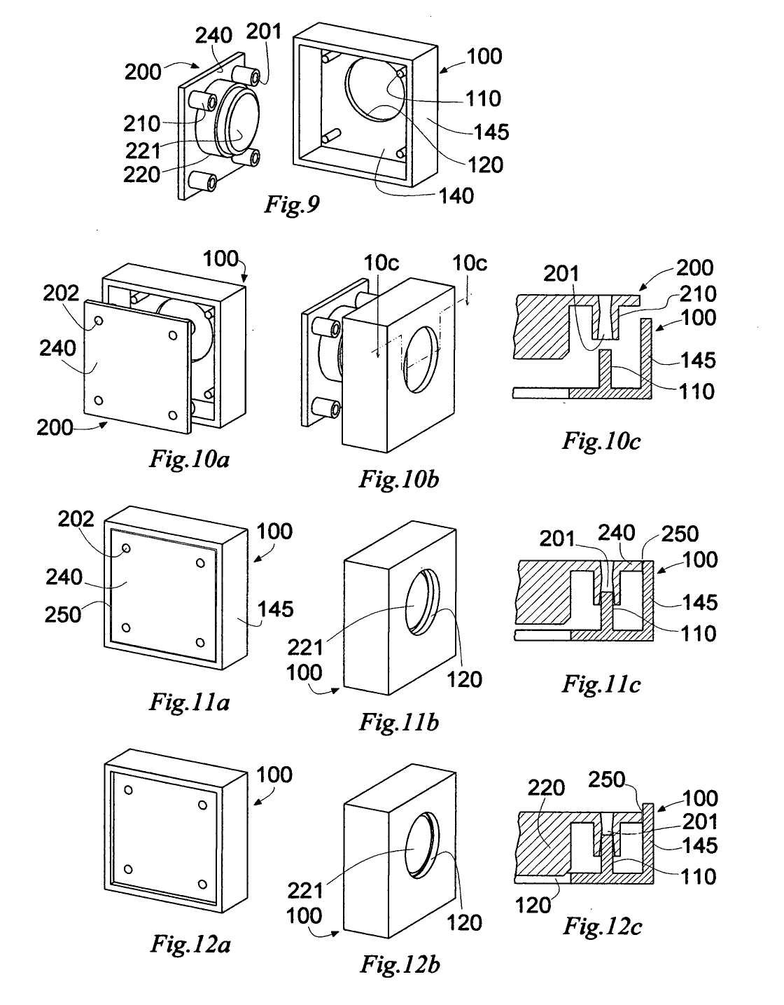

FIG. 9 depicts the present invention in a generic application wherein box like assembly 100 has four studs 110, aperture 120 in front wall 140, and side walls 145. Mating assembly 200 has four bosses 210 having double-tapered, open holes with funnel portions 201 at their free ends, and layer-cake like projection 220 extending from rear wall 240 and ending in face 221. Projection 220 might contain a dial-works and face 221 might be a transparent cover.

FIGS. 10a, b, and c are representations of assemblies 100 and 200, wherein bosses 210 and studs 110 are now in registry with one another, but funnel portions 201 have not yet been lowered over studs 110.

In FIGS. 11a, b, and c funnel portions 201 have been lowered over studs 110, but have not yet made contact with them. It is apparent that, before any actual connection has been effected, studs 110 along with funnel portions 201 guide parts assembly. Any sideways movement will be stopped at this point by their contact. Gap 250 between side walls 145 and rear wall 240 is too narrow to allow the glib insertion of prying tools.

In FIGS. 12a, b, and c funnel portions 201 have been lowered into first contact with studs 110. Although a connection has not yet been made, face 221 has already extended into aperture 120, thus facilitating proper assembly. By choosing the depth of the neck in bosses 210 and the lengths of studs 110 with attentiveness to the height of face 221 relative to wall 240, parts may be deterred from skewing during their actual connection.

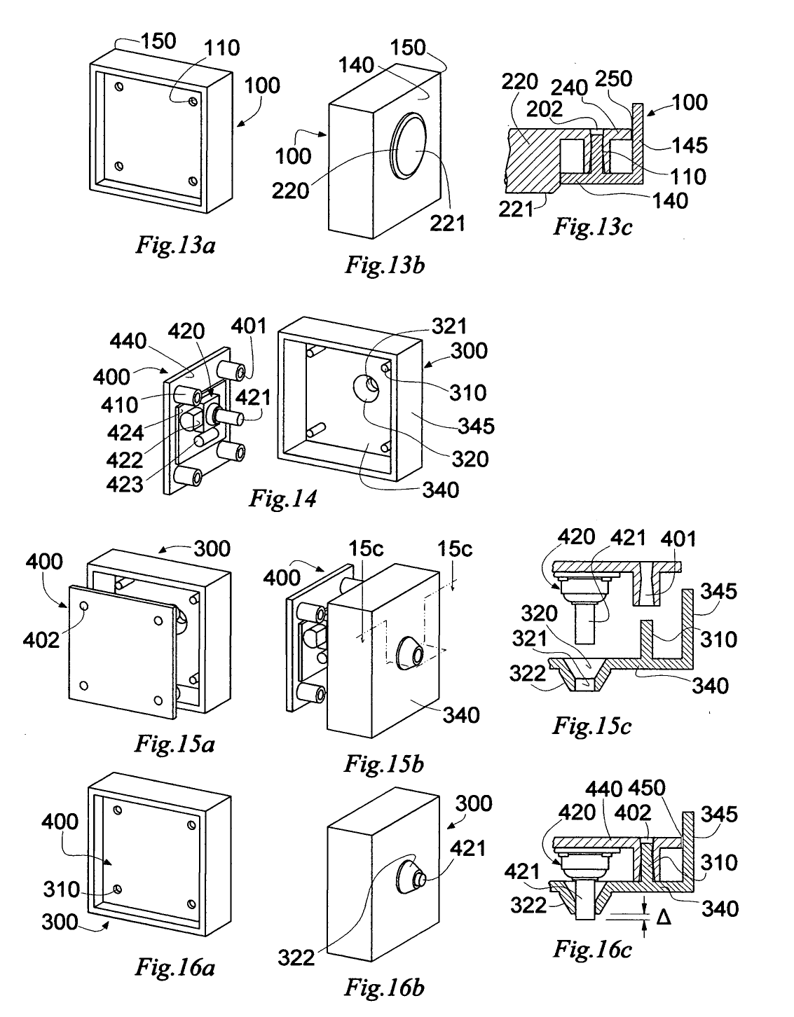

In FIGS. 13a, b, and c bosses 210 have been pushed over studs 110 as far as studs 110 will go in, thus effecting full connection of assemblies 100 and 200. Face 221 of projection 220 now stands proud of wall 140, while funnel portion 202 is available for chemical deposition, if desired. Side wall 145 is so close to rear wall 240 that the now-finished product probably can be left untreated, provided only that the forces applied orthogonally to face 221 are not anticipated to be stronger than the connection strength by a factor of at least four in this example. In day to day use, even an accidental drop from a table to a floor is unlikely to compromise the four connections, but instead will probably just bruise some part of the product, such as corner 150. Prying tools forced into gap 250 will visibly mar the product, voiding the warranty.

FIG. 14 depicts the present invention in a generic application wherein box-like assembly 300 has four studs 310, funnel shaped aperture 320 in front wall 340 terminating in cylindrical portion 321, and side walls 345. Mating assembly 400 has four bosses 410 having double-tapered holes with funnel portions 401 at their free ends. Affixed to rear wall 440 is printed circuit board 424 comprising tact switch 420, itself comprising push button 421, plus transistor 422 and resistor 423.

FIGS. 15a, b, and c are representations of assemblies 300 and 400, wherein bosses 410 and studs 310 are now in registry with one another but funnel portions 401 have not yet been lowered over studs 310. Conical boss 322 on wall 340 is likewise in registry with push button 421.

In FIGS. 16a, b, and c bosses 410 have been pushed over studs 310 as far as studs 310 will go in, thus effecting full connection of assemblies 300 and 400. Push button 421 now extends through conical boss 322 a distance A. Movement of push button 421 through distance A is just sufficient to close normally open tact switch 420. Funnel portion 402 is available for chemical treatment, if desired. Gap 450 between side wall 345 and rear wall 440 is very narrow. Note that by allowing push button 421 to extend beyond boss 322 no more than is electrically necessary also greatly limits the amount of force that can be transmitted through tact switch 420 via circuit board 424 and ultimately to the connection formed by studs 310 and bosses 410. In practice, the force transmission is negligible.

It should be noted that the choice in the foregoing of rotationally symmetric, cylindrical studs and conical double-tapered holes was merely a reflection of molding convenience. The present invention may be embodied in means that employ any other convex, cross sectional geometry provided only that the narrowest cross section of the double-tapered open hole is smaller than any cross section of the stud capable of being engaged by the narrowest cross section of the hole, and that all engageable cross sections of the stud and the hole are geometrically similar, and further provided that all cross sections are in registry and are taken orthogonally to the same line in space.

These relations are illustrated in FIG. 17 showing square stud 511 on wall 514 of element 500 and round boss 624 on wall 623 of element 600. Boss 624 and wall 623 have square, double-tapered hole 629 comprising square funnel portions 621 and 622 extending completely through boss 624 and wall 623, and square neck 626. All cross sections of stud 511 are orthogonal to line 35, are geometrically similar to the smallest orthogonal cross section of hole 629, namely to neck 626, and are in registry with each other, signifying that stud 511 has no twist along its length. Elements 500 and 600 still remain free to move in any direction. A rectangular, instead of square, cross section throughout would yield a still more general embodiment.

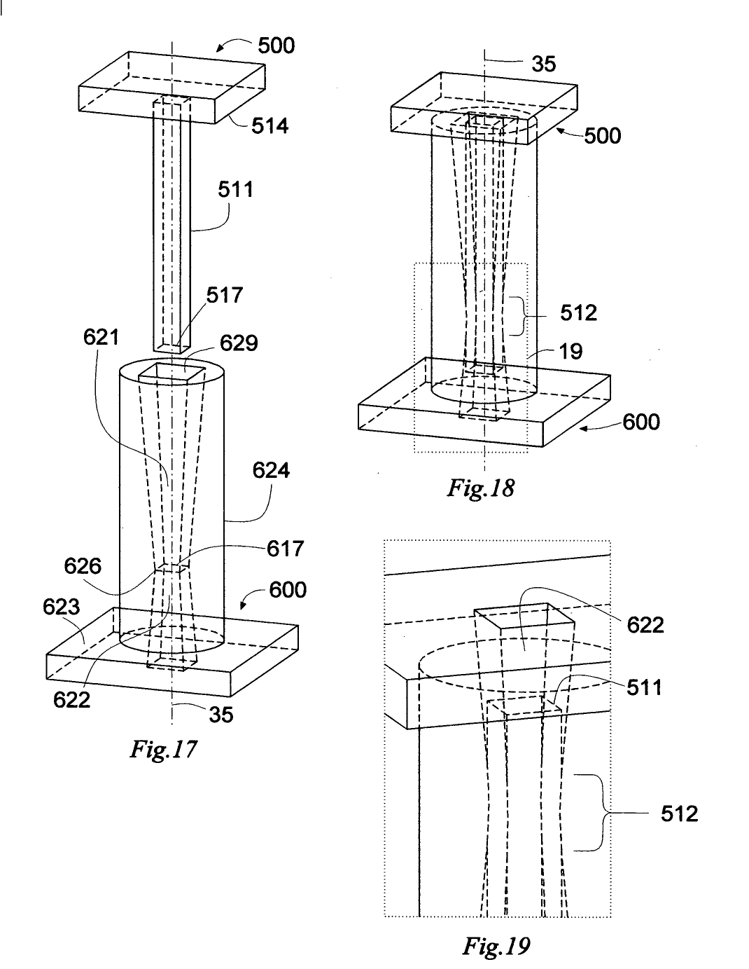

In FIG. 18, square stud 511 and square double-taper hole 629 have been forced into full engagement, resulting in mutual, Hook's law deformation in region 512. The strength of the connection of elements 500 and 600 depends on the extent of the deformation in region 512, which extent may be varied by altering the ratio of the length of side 517 to side 617 (see FIG. 17) or by altering the ratio of those sides' second powers, namely the ratio of the area of the cross sections of stud 511 and neck 626, prior to their elastic deformation.

FIG. 19 shows the cavity formed by square funnel portion 622 and stud 511, and sealed off by region 512.

Inasmuch as modifications and alterations apparent to one skilled in the art may be made to the herein described embodiments of the present invention without departing from the scope and spirit thereof, it is intended that all matter contained herein be interpreted in an illustrative, and not in a limiting, sense with respect to the invention claimed in the following claims and equivalents thereto.

I claim:

1. A means for connecting plastic parts integrally formed therewith and comprising at least one stud and at least one double-tapered, open hole, said double-tapered open hole having a smallest cross section smaller than and geometrically similar to any cross section of said stud capable of being engaged by said double-tapered, open hole, said cross sections being taken orthogonally to the same line in space and each said cross section being in registry with any other, said smallest cross section forming a neck within said double-tapered, open hole, and said stud being disposed so that it and said double-tapered open hole can be pressed together such that a portion of said stud passes through and past said neck, thereby elastically deforming and connecting said plastic parts.

2. A means of connection as in claim 1 in which said cross sections are circular.

3. A means of connection as in claim 1 in which said cross sections are rectangular.

4. A means of connection as in claim 1 wherein the position of said neck within said double-tapered, open hole may be chosen relative to the length of said stud in order to place said plastic parts in unskewed alignment with one another before said parts are connected during said parts' assembly.

5. A means of connection as in claim 4 in which one of said plastic parts comprises a circuit board and the other of said plastic parts has a wall with an aperture therein, and wherein an element of said circuit board protrudes through said aperture after said plastic parts have been connected.

6. A means of connection as in claim 4 and in which one of said plastic parts comprises a wall and a member proud of said wall, and the other of said plastic parts has a wall with an aperture therein, and wherein said member protrudes through said aperture after said plastic parts have been connected.

7. A means of connection as in claim 1 wherein said double-tapered, open hole has a vertex angle common to both tapered portions of said double-tapered, open hole.

8. A means of connection as in claim 7 wherein said stud has a vertex angle and wherein said vertex angle of said stud is greater than or equal to zero but less than said common vertex angle of said tapered portions of said double-tapered open hole.

9. A means of connection as in claim 1, wherein at least one of said plastic parts is molded.

10. A means of connection as in claim 1, wherein at least one of said plastic parts is milled.

11. A means of connection as in claim 1, wherein said elastic deformation of said plastic parts is a Hook's Law deformation.

12. An means for connecting plastic parts integrally formed therewith and comprising at least one stud and at least one double-tapered, open hole, said parts when connected by said stud and said double-tapered, open hole forming a cavity sealed by said connection into which chemical means may be deposited to effect a permanent connection of said plastic parts.

13. An means for connecting plastic parts integrally formed therewith and comprising at least one stud and at least one double-tapered, open hole, wherein said double-tapered, open hole has a least cross section orthogonal to a line in space, and further wherein said stud has a cross section orthogonal to said line and engageable by said least cross section of said double-tapered, open hole, and wherein the ratio of a measure of said least cross section of said double-tapered, open hole to a like measure of said engageable cross section of said stud can be chosen prior to the connection of said plastic parts to achieve a desired strength of the connection of said plastic parts.

14. A means as in claim 13 in which said measure is an area.

15. A means as in claim 13 in which said measure is a linear dimension.
